(19) United States
(12) Patent Application Publication
(10) Pub. No.: US 2023/0058452 A1
(43) Pub. Date: Feb. 23, 2023

(54) EFFICIENT ERROR REPRODUCTION SCENARIOS THROUGH DATA TRANSFORMATION

(71) Applicant: SAP SE, Walldorf (DE)

(72) Inventors: Seunghwan Baek, Seoul (KR); Changyun Seo, Seoul (KR)

(73) Assignee: SAP SE, Walldorf (DE)

(21) Appl. No.: 17/404,824

(22) Filed: Aug. 17, 2021

(51) Int. Cl. G06F 11/07; G06F 11/34; G06F 11/32; G06F 11/36

(52) U.S. Cl. CPC G06F 11/0793; G06F 11/321; G06F 11/3414; G06F 11/3656

(57) ABSTRACT

Systems, methods, and computer media are described for creating efficient error reproduction scenarios. Raw workload capture data can be consolidated based on transactional dependence of the requests in the capture data. The consolidated workload capture data can be stored as a separate data structure that can be accessed to identify requests on which a request of interest in the raw workload capture data is transactionally dependent. For a request of interest (e.g., a request that caused an error), a lightweight error reproduction scenario can be generated that includes the identified transactionally dependent requests and excludes unrelated requests.

### BACKGROUND

Modern software has become increasingly dynamic and complex. It is often difficult to perform an adequate evaluation of how the software will behave in the field. Despite testing, some software errors typically do occur during real-world use. To help analyze the root sources of errors, error reproduction scenarios can be generated that include the sequence of workloads relevant to the errors.

### BRIEF DESCRIPTION OF THE DRAWINGS

FIG. 1 illustrates an example method of generating an efficient error reproduction scenario.

FIG. 2 illustrates an example system configured to generate an efficient error reproduction scenario.

FIG. 3 illustrates example workload capture data that is analyzed for dependencies.

FIG. 4 is an example data structure containing consolidated workload capture data.

FIG. 5 is an example of predecessor search.

FIG. 6 illustrates transactionally consistent ordering in error reproduction scenarios.

FIG. 7 illustrates an example method of generating an efficient error reproduction scenario in which related objects are grouped.

FIG. 8 is a diagram illustrating a generalized implementation environment in which some described examples can be implemented.

### DETAILED DESCRIPTION

Reproducing software defects or malfunctions is often part of the process of diagnosing and resolving bugs. While reproducing malfunctions, programmers can apply various analysis tools to locate the point at which the program went astray. In a database management system for handling massive concurrent workloads from enterprise applications, developing an error reproduction scenario can be challenging.

The examples described herein generally relate to efficient error reproduction scenarios. Error reproduction scenarios are generated based on workload capture data, which is the data recorded during an application session (e.g., queries and other requests (also referred to as workloads or transactions) made between an application and a database or other data store). When errors occur during a session, relevant portions of the corresponding workload capture data can be used to recreate the scenario in which the error occurred.

Tools (such as, e.g., SAP HANA Capture and Replay) can allow users to capture workload transactions from a source database system and to replay the captured transactions on a target database system. Such tools aim to reduce the manual efforts necessary for assembling systematic groundwork where the entire captured workloads are executed in the same sequence during the replay phase as was done during the capture phase. Transactionally consistent ordering among the captured requests is needed during the replay phase for accuracy. As a result, a series of state changes in the database system, including any deterministic symptoms, made during the capture phase can be reproduced during the replay phase.

In the workload capture phase, an initial database backup can be created, and transactional information can be collected as application requests are being executed in a source database system. In a replay phase, a database recovery can be performed on a target database system using the initial database backup, and a configuration setting can be performed to guarantee an identical database system setting. Using the transactional information, requests are executed in a transactionally consistent sequence on a target database system.

A workload capture can consist of an extremely heavy number of requests (e.g. multi-billion requests) with exhausting replay duration (e.g. 48 hours). Hence, it can frequently be unrealistic to gain complete understanding of the meaning behind such application transactions. Additionally, there may exist complex interdependence among the requests. Interdependence, also known as transactional dependency, may exist between two requests if the follower request execution must consider state changes of the underlying database objects that occurred during the preceding request execution.

The described examples create efficient error reproduction scenarios by consolidating workload capture data (e.g., into a compact data structure) based on transactional dependence of the various requests in the capture data. A lightweight reproduction scenario can be extracted using the consolidated workload capture data that contains the relevant sequence of operations for retriggering a target system failure (i.e., those upon which the failure is transactionally dependent) but omits operations that are not relevant to the failure (i.e., those on which the failure is not transactionally dependent).

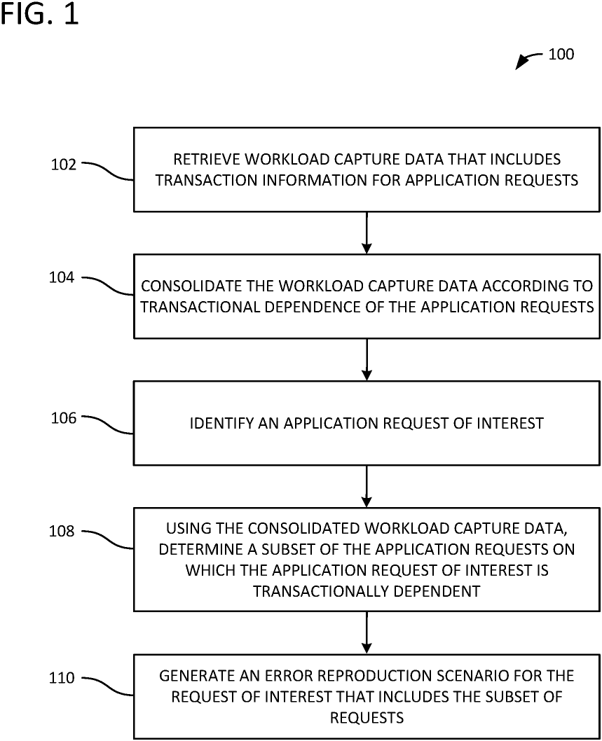

By consolidating workload data based on transactional dependency, accurate and efficient error reproduction scenarios can be generated that greatly reduce the computing resources and time used to reproduce an error (e.g., system failure) for debugging. Examples are described below with reference to FIGS. 1-8.

When the causes of a software malfunction (also referred to as the target symptom) are not clear, a reproduction scenario is useful for further investigation. Executing the target request, where the symptom was observed, on a recovered database system alone does not necessarily reproduce the target symptom. One reason for this is the consequent changes made in the database system as the database objects get altered throughout the replay. Instead, requests that perform a series of relevant database state changes to provoke the target symptom can be pinpointed and collected. That is, those having a semantic relationship to the target request can be identified while ruling out others.

In some uses, “request” can refer to what an application sends to a server (e.g., a database server), and “workload” can refer to what the (e.g., database) system is required to process or execute based on the request, but in this document, the two terms are used interchangeably. An example of a request is a structured query language (SQL) command.

As used here, semantic relatedness refers to the interconnection among requests by their database query statements sharing an underlying object hierarchy tree. Preceding requests having semantic relatedness to a given request are referred to as predecessors. The process of identifying predecessors is referred to as a predecessor search. A predecessor search is challenging due to the overwhelming amount of transactional information describing concurrency and execution dependency of all the requests. Increases in complexity of underlying database object hierarchy induce a drastic degradation in the predecessor search performance.

In the described approaches, execution order among requests in a session can be determined and execution order between every pair of requests linked by their transactional dependency and scheduled directly one after another can be determined. To summarize, it is possible to determine the execution order among requests in the entire capture. To state it differently, it is possible to identify preceding requests of any given request.

Requests can be processed by running a database query statement (e.g., structured query language (SQL) queries, stored procedures, functions) over underlying database objects. If the underlying database object information for every request in the capture were known, then requests that share the same object hierarchy tree with the target request could be collected. Tools such as SAP Capture and Replay collect a list of related database objects for each request execution. The list contains a few of the most closely related objects to the ones explicitly mentioned in the database query statement. The purpose of collecting these lists is to identify pairs of requests that are linked by their transactional dependency and scheduled directly one after another. The lists, however, do not provide full information to identify every object in an object hierarchy tree. Yet, such information is needed to determine the complete semantic relatedness among the requests in the entire capture.

Other objects that are also in the object hierarchy tree can be further discovered by inspecting the entire capture data. Since numerous object hierarchy trees may exist in the database system, it can take an extensive amount of time to group every object correctly according to object hierarchy trees (i.e., object group). In some situations, this process may involve analyzing billions of related object lists (i.e., billions of execute-type requests), with each list containing hundreds of object IDs in the worst case. An increase in the complexity of individual database object hierarchy may cause a severe performance degradation during the predecessor search with most of the search time consumed during object hierarchy exploration. The described examples offer a performance-enhanced method for accelerating the predecessor search.

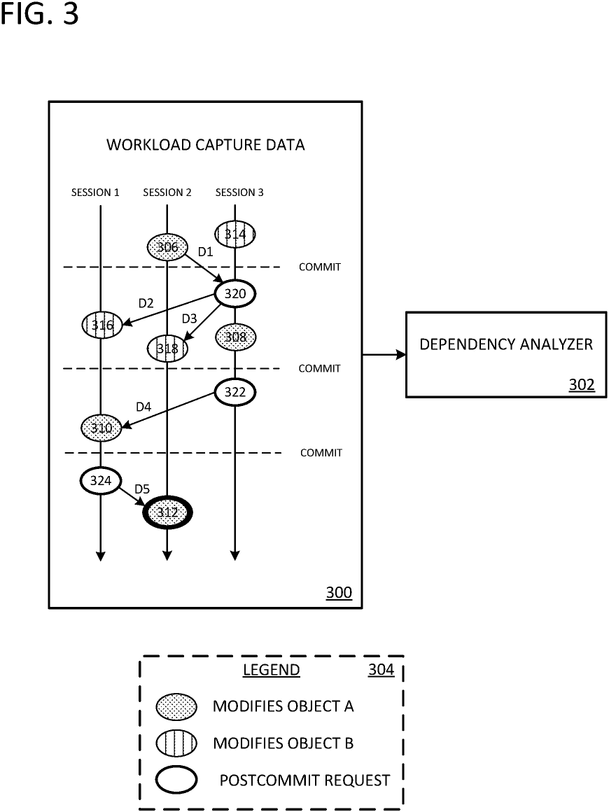

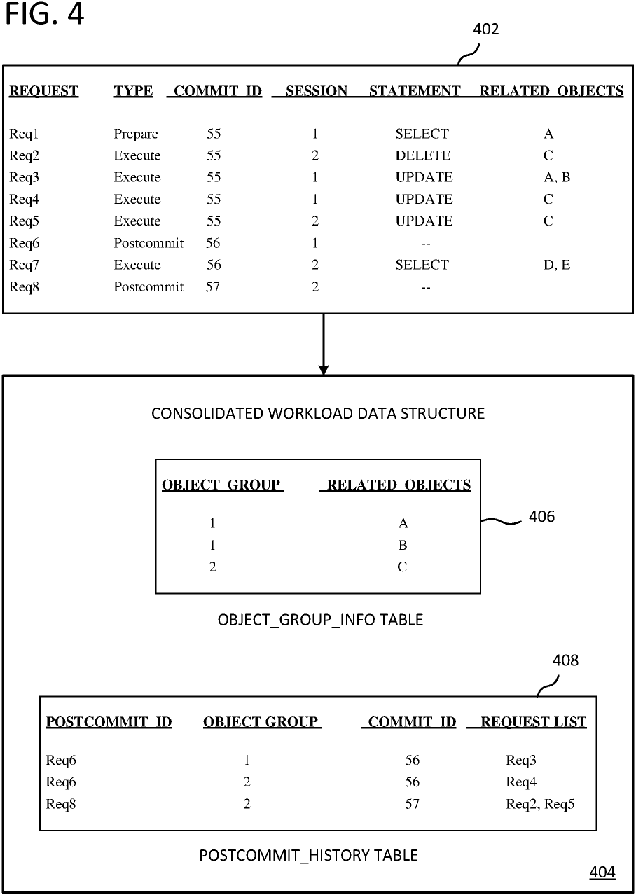

FIG. 1 illustrates a method 100 of generating an efficient error reproduction scenario. In process block 102, workload capture data is retrieved. Workload capture data can be recorded as requests are received and be available for later retrieval. The workload capture data includes transaction information for a plurality of application requests. The requests include queries made by the application to a database or other data store to access, modify, update, delete, or otherwise interact with the database. The transaction information can include, for example, an identifier for the request, an operation type, a structured query language (SQL) statement type, and/or one or more related objects for the request. Example workload capture data is illustrated in FIGS. 3 and 4.

In process block 104, the workload capture data is consolidated according to transactional dependence of the plurality of application requests. The transaction information can list related objects for the respective application requests. Consolidating the workload capture data can further comprise grouping objects listed as related objects into object groups. Objects in an object group are part of a same object hierarchy tree of dependency. Although the object hierarchy tree itself is not evident from workload capture data, objects in an object group are part of the same object hierarchy tree(s). As an example, upon determining that first and second objects are listed as related objects for one of the plurality of application requests in the workload capture data, the first and second objects can be assigned to a first object group. Upon determining that for other of the plurality of application requests, one or more other objects are listed along with either the first or second objects as related objects, the one or more other objects can also be assigned to the first object group.

As a specific example, consider the requests and related objects shown below in Table 1.

Table 1

Example request IDs and related objects

| REQUEST_ID | RELATED_OBJECTS |
|---|---|
| 1 | A, B |
| 2 | C |
| 3 | A, D |

First, an empty object group info table is created: { }. After examination of request 1, A and B are both identified as part of the same object hierarchy tree and thus belong in a same object group. The table can then be updated to: {1: [A, B]} (where “1” indicates object group 1). Examining request 2, related object C is not already part of an object group, and there are no other related objects for request 2, so a second object group is created with object C. The table can then be updated to {1: [A, B], 2: [C]} (where “2” indicates object group 2).

Examining request 3, a check is made to determine if objects A or D are already part of an object group. After determining that object A is already part of object group 1, object D is also added to object group 1 (because A and D are listed together as related objects). The table can then be updated to {1: [A, B, D], 2: [C]}. Such an approach can be used to traverse all the requests in the retrieved workload capture data to form object groups.

Other more performance-optimized approaches can also be used for grouping objects to conduct grouping in a desired time (e.g., to meet performance goals). Such approaches can be difficult to implement given the large number of related object lists (i.e. of execute-type requests in the capture) that need to be examined and given that an individual object list provides only partial information about an object hierarchy tree.

Traversing the entire object lists in the capture can be bypassed by initially grouping the execute-type requests according to their corresponding SQL statements (or equivalently, statement hash information). In doing so, the total number of distinct related object lists to examine is greatly reduced. Here, an SQL statement may be mapped to either a unique related object list (i.e. 1-to-1 mapping) or to multiple related object lists with or without common objects (i.e. 1-to-N mapping). For the different cases, the most efficient ways of discovering relationships among objects and grouping the objects must be determined.

Additionally, when using multiple worker processes in parallel to facilitate object grouping, in some instances a huge volume of outdated/invalid insertion jobs can be produced causing tremendous delays, because each worker running in parallel does not necessarily perform correct object grouping given only limited information (e.g., partial information about object hierarchy trees), and, thus, it requires huge effort to correct previously performed outdated/incorrect object grouping. To accelerate the performance of such a task, an optimized method can be applied to limit outdated/invalid insertions and to complete object grouping with reduced effort. This is a well-known problem of utilizing multiple process workers for updating a single table in parallel. Any optimized approach can be selected as a solution. (As used herein, “optimized” does not necessarily refer to a “best” approach and includes a variety of approaches that offer improved performance.)

As an outcome after grouping, a data structure can be generated that relates identifiers for object groups and objects that form the corresponding object groups (such as a table like what is shown in Table 1).

Requests can be of various types, including “execute-type” requests (such as DELETE or UPDATE request types in SQL) and “postcommit-type” requests, which are acknowledgments of commit transaction completion. Consolidating the workload capture data can further comprise grouping the execute-type requests according to identifiers of the corresponding postcommit-type requests. An example of this is shown in FIG. 4. In some examples, a data structure relating execute-type requests and corresponding postcommit-type requests is generated. This is also illustrated in FIG. 4.

In process block 106, an application request of interest is identified. The request of interest can be, for example, the request on which the root cause of its execution failure requires a further investigation. In process block 108, using the consolidated workload capture data, a subset of the plurality of application requests on which the application request of interest is transactionally dependent can be identified. For example, a data structure storing consolidated workload capture data can be searched to identify requests having the same object hierarchy tree as the request of interest.

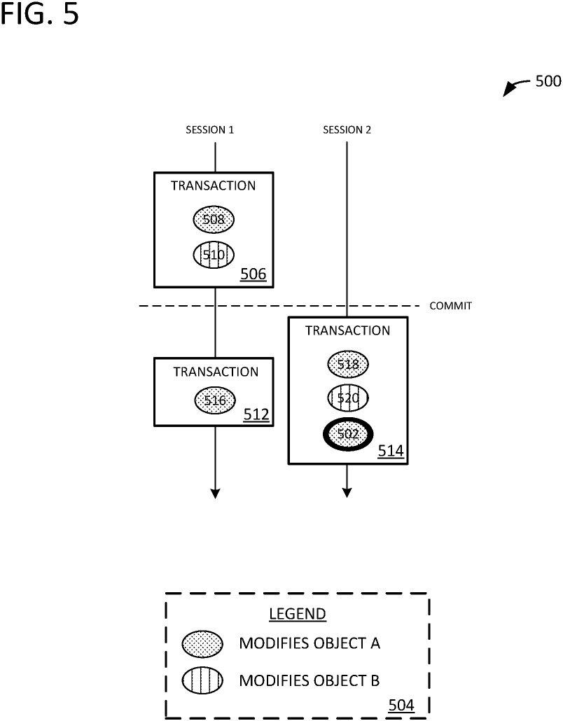

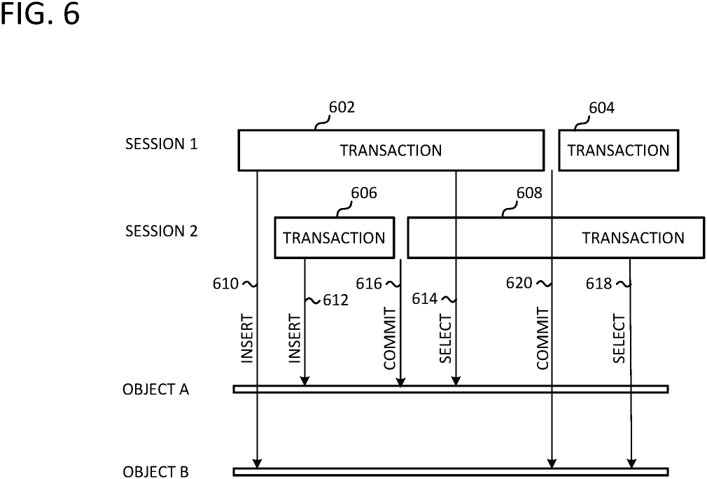

In process block 108, an error reproduction scenario is generated for the application request of interest, the reproduction including the subset of application requests on which the application request of interest is transactionally dependent. Generating the error reproduction scenario can also include ordering the plurality of application requests on which the application request of interest is transactionally dependent. Efficient error reproduction scenarios are discussed in more detail with respect to FIGS. 5 and 6.

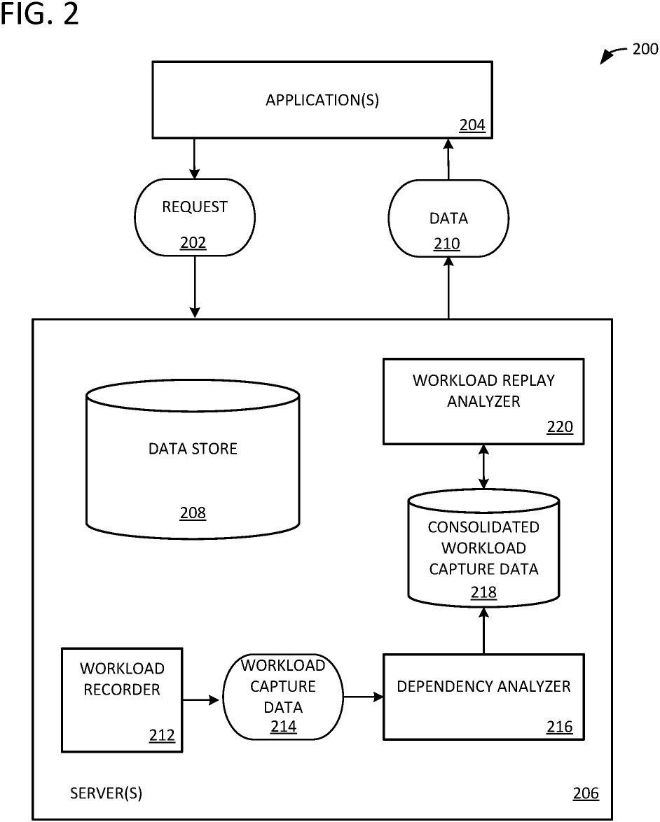

FIG. 2 illustrates an example system 200 for generating efficient error reproduction scenarios. A request 202 is made by application(s) 204 to server(s) 206. The application can be the front end of a cloud application or a local application. Request 202 involves performing an action on data store 208, which can be a database or other data store. Example actions include SQL action types such as SELECT, UPDATE, DELETE, etc. Server(s) 206 modifies data store 208 and/or provides data 210 back to application(s) 204.

Over a period of time, the requests made by application(s) 204 are recorded by workload recorder 212 and form workload capture data 214. Workload capture data 214 can be analyzed by dependency analyzer 216 and consolidated (e.g., using object hierarchy trees and organized by postcommit request as discussed with respect to FIG. 1) into consolidated workload capture data 218. Workload replay analyzer 220 can access consolidated workload capture data 218 to create an efficient error reproduction scenario for requests of interest that, e.g., caused a software error. The efficient error reproduction scenarios include transactionally dependent data that is needed to reproduce the error while omitting huge amounts of irrelevant data, thus conserving large amounts of computing resources and improving execution times.

FIG. 3 illustrates example workload capture data 300 that is consolidated by a dependency analyzer 302. Dependency analyzer 302 can be similar to dependency analyzer 216 of FIG. 2. FIG. 3 also illustrates the concept of postcommit requests and execute-type requests and shows three types of requests, as illustrated in legend 304. Ovals with the dotted fill are execute-type requests that modify object A (requests 306, 308, 310, and 312), ovals with vertical striped fill are execute-type requests that modify object B (requests 314, 316, and 318), and ovals with no fill and a bolded border are postcommit-type requests (requests 320, 322, and 324). Three horizontal dashed lines indicate when UPDATE execute-type transactions are committed, and the three vertical lines correspond to three different sessions for different users or applications. No relation is assumed between objects A and B.

The post-commit type request is an acknowledgment of a transaction commit completion. In some database systems, for example, the execute-type requests are committed as a group within a transaction by default. As shown in FIG. 3, there exist several transactional dependencies among requests (labeled as D1, D2, ..., D5). To reproduce a symptom on request 312 which is shown to alter object A, the predecessor search should consider transactional dependencies due to semantic relationships made by object A (i.e., D1, D4 and D5) while disregarding others. In the predecessor search, the major time-consuming operation is searching for all transactional dependencies that are relevant to the current search within the entire capture data.

In the described approaches, enhanced efficiency is provided by (1) a rapid compilation of the entire transactional information within the capture data and (2) a transformation into a compact and easily retrievable form to enable fast look up during the predecessor search to quickly generate an error reproduction scenario. Consider the following detailed examples.

### Compiling Transactional Information

The related objects contained in the capture data can be examined, and it can be determined which objects are part of the same underlying object hierarchy tree and, therefore, belong to the same object group. During a transaction execution, state changes of multiple underlying object hierarchy trees are possible. Compiling the entire transactional information may take an extensive amount of time because the process can involve analyzing billions of the related object lists, with each list containing hundreds of object IDs. Nonetheless, completion within a reasonable time is desired.

In some examples, instead of scanning related object lists of billions of requests, the described approaches examine related object lists for each unique database query statement, which is a much smaller amount. In an experiment, for a workload capture of 375 million request executions performed during the capture phase, there were only one million unique database query statements. Here, a caveat is that it is not correct to always assume a one-to-one relationship between a database query statement and a distinct related object list. To be specific, requests with the same database query statement can have different related object lists due to multiple reasons, such as: (1) a different object ID may be assigned to a database object even though the object is being created with the same object name, or (2) a database query statement can have different input parameters.

In an experiment, the compilation step completed within 1.4 hours for processing a capture of size 62 GB containing 375 million request executions. The outcome is two data tables: (1) an auxiliary table “OBJECT_GROUP_INFO” containing an integer-type object group ID assignment for every object ID in the capture (an example is shown in FIG. 4 as table 406), and (2) an intermediate table (not shown) containing object group ID assignments for every request in the capture. The intermediate table can be further transformed into a compact data structure.

### Transforming Transactional Information

The intermediate table can be transformed into a compact and easily retrievable data structure to enable fast look up during predecessor search. In some database management systems (DBMSs), execute-type requests are committed as a group (i.e., by transaction) by default. When a transaction commit completes, a postcommit-type request is generated as an acknowledgment. Transformation can consist of two steps: (1) collecting postcommit-type requests with information of their transactions (e.g., list of execute-type requests, commit timestamp, etc.), and (2) performing further grouping on execute-type requests in a transaction according to their object group IDs (object hierarchy trees). Depending on the number of different object groups involved in a transaction, the execute-type requests will form multiple groups which will then be represented as multiple records in a second auxiliary table, “POSTCOMMIT_HISTORY.”

FIG. 4 illustrates example raw capture data 402 and a corresponding consolidated workload data structure 404 that includes the OBJECT_GROUP_INFO table 406 and POSTCOMMIT_HISTORY table 408. In some examples, each of tables 406 and 408 are separate data structures.

As shown in raw capture data 402, two execute-type requests (Req3 and Req4) belong to the same transaction (i.e., identical COMMIT_ID and SESSION). Their transaction is committed with postcommit-type request (Req6). As shown in table 406, their underlying database objects belong to different object groups (i.e., 1 and 2, respectively). Therefore, their information is stored as two separate records in POSTCOMMIT_HISTORY table 408.

In an experiment, the transformation completed within 2.1 hours and produced 1.2 GB of export data for a capture of size 62 GB containing 375 million request executions. In the export, the transactional information and object group information within the entire capture data are compiled into compact auxiliary data structures.

### Error Reproduction Scenario Extraction

Once a compact data structure has been generated, error reproduction scenario extraction can be performed.

Predecessor Search: For the target request, transactional information is first looked up from the capture data (e.g., related object list, commit ID, update transaction ID, etc.). Here, an update transaction ID is a unique ID assigned to a data altering-type transaction. To non-data altering-type transactions, a zero value is assigned as an update transaction ID. After obtaining the related object list of the target request, the object group ID can then be looked up.

FIG. 5 illustrates a series of transactions 500 on which predecessor search can be performed. Suppose that the target request is request 502. As illustrated in legend 504, requests that modify object A are shown with dotted fill, and requests that modify object B are shown with vertical lines as fill. Assume no relation exists between object A and object B. Transaction 506 contains requests 508 and 510. Transaction 506 and transaction 512 are executed on the same connection (i.e., Session 1). Transaction 506 is committed before transaction 512 or transaction 514 start. Transaction 512 includes request 516, and transaction 514 includes requests 518, 520, and 502 (which is the target request).

Using the described examples, the object group assignment of every execute-type request in the capture can be determined. In addition to being associated with identical object groups as the target request, requests must satisfy at least one of the following conditions to qualify as a predecessor: (1) they belong to a transaction which is committed before the transaction of the target request starts (e.g. request 508); (2) if the update transaction ID of the target request is non-zero, they are preceding requests committed in the same transaction with the target request (e.g. request 518); or (3) if the update transaction ID of the target request is zero, they are preceding requests in a transaction with identical commit ID and non-zero update transaction IDs. This information can be rapidly retrieved from the consolidated workflow data (e.g., the compact data structure).

DDL Statement Execution Support: A reproduction scenario runs in accordance with the target database state, initially recovered with the database backup, to prevent predecessor execution failures due to data inconsistency. Thus, it can require an additional support for DDL-type (Data Definition Language) statement executions. During the reproduction scenario run, a CREATE-type statement execution would terminate in error if an object by the same name already exists in the target database system. Moreover, erroneous operations would follow if the object by the same name has been created by a different definition. To be specific, there are two possible cases of a database object creation: (1) if an object gets deleted while its underlying database objects still exist, then a new object with the same object name will be assigned to the same object ID, and (2) if an object gets deleted after all underlying database objects have been deleted, then a new object with the same object name will be assigned to a different object ID.

The concerning situation is case (2). Operation history (i.e., request executions) of a database object would be lost if multiple different object IDs were assigned to it consecutively during the capture phase. Therefore, it requires additional effort to maintain the consistency between the reproduction scenario and the target database state. For every object ID in the target object group, it is checked whether the following two conditions hold true: (1) create has occurred at least once during the capture, and (2) an object with the same object name already exists in the database. If both conditions hold true, then any drop request of an identical object name but of different object ID prior to the first create request of this object ID must be searched for and added to the reproduction scenario.

Transactionally Consistent Execution: The transactional information collected within the capture data can be analyzed to ensure a transactionally consistent replay. Transactional consistency is also maintained among the predecessors. To describe how the described approaches achieve this, several types of information available in the capture data are first defined: (1) among requests executed in an identical session, their logical execution sequence can be determined by an integer-type ID assigned to them uniquely within a session (SQL_OPERATION_SEQUENCE); (2) a commit timestamp is generated, as a universally unique integer value in the entire capture, to indicate, relative to the starting time of the capture, when a transaction commit completes (SQL_COMMIT_ID); and (3) a connection ID information is collected for every transaction in the capture (CONNECTION_ID).

A request execution order can be of two types: (1) the order among requests within a session and (2) the order among requests from different sessions due to the transactional dependency. For case (1), SQL_OPERATION_SEQUENCE provides a logical request execution order within a session. For case (2), it requires a complex administration to decide whether database object changes made during the preceding transaction(s) should be visible to the follower transaction(s).

This is illustrated in FIG. 6. The changes made in a transaction from one session become visible to transactions from other sessions only after the changes are committed successfully. Again, no relation is assumed between objects A and B. FIG. 6 shows transactions 602 and 604 for a first session, Session 1, and transactions 606 and 608 for a second session, Session 2. Because A and B are not related, it does not matter in which order INSERT 610 from Session 1 and INSERT 612 from Session 2 get executed because they alter different database objects (A and B). However, SELECT 614 from Session 1 must wait for COMMIT 616 from Session 2 to complete because they have object A in common. Likewise, SELECT 618 from Session 2 must wait for COMMIT 620 from Session 1 to complete because they have object B in common.

Preserving transactional consistency means not only making the correct execution order among requests in transactional dependency but taking full control over when to trigger individual request executions so that visibility of data change is always made consistent throughout the course of request executions. To make such management possible, several types of timestamp information can be examined simultaneously. SQL_OPERATION_SEQUENCE can be used for determining the order among requests within a session. SQL_COMMIT_ID indicates when a transaction commit completes. As an example, in FIG. 6, transaction 602 and transaction 606 belong to Sessions 1 and 2, respectively. After COMMIT 616 from Session 2 completes, the SQL_COMMIT_ID of a postcommit-type request (created implicitly after COMMIT 616) and following requests will be incremented by one. This guarantees a correct ordering between INSERT 612 and SELECT 614.

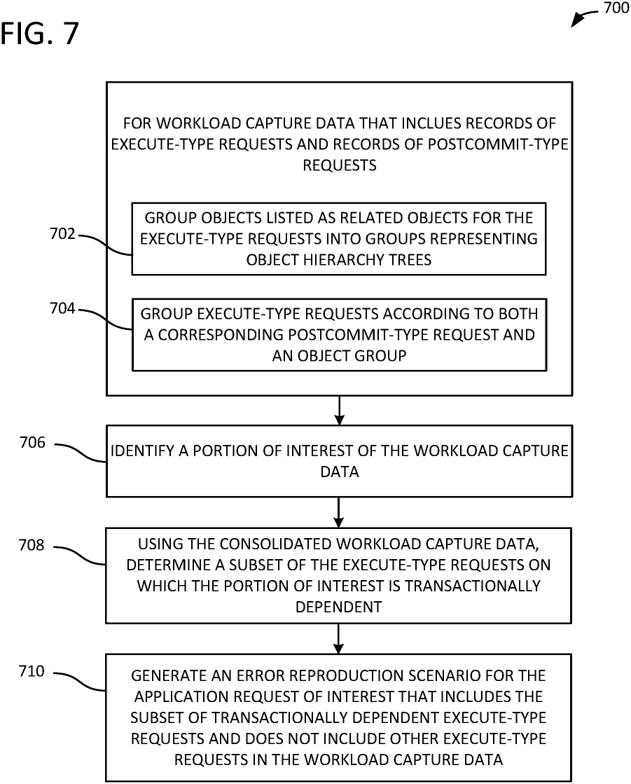

FIG. 7 illustrates a method 700 of efficiently generating error reproduction scenarios. Process blocks 702 and 704 are performed for workload capture data that includes records of execute-type requests and records of postcommit-type requests. In process block 702, objects listed as related objects for the respective execute-type requests are grouped into object groups representing object hierarchy trees. In process block 704, the execute-type requests are grouped according to both a corresponding postcommit-type request and an object group. The grouped objects and execute-type requests form consolidated workload capture data.

In process block 706, a portion of interest of the workload capture data is identified. This can be, for example, a “target symptom” or request that caused a software malfunction. In process block 708, a subset of the execute-type requests on which the portion of interest is transactionally dependent is determined. In process block 710, an error reproduction scenario for the application request of interest is generated. The reproduction includes the subset of transactionally dependent execute-type requests and does not include other execute-type requests in the workload capture data. Process blocks 708 and 710 can be done, for example, through the process discussed with reference to FIGS. 5 and 6.

### Experimental Results

In an experiment, four bug situations were selected, as representatives, for which the numbers of objects in the hierarchies ranged from 2 to 8,231. Without efficient error reproduction scenarios, as the complexity of underlying object hierarchy grows, the predecessor search suffers performance issues. On the other hand, after applying the described approaches, the predecessor search elapsed time remains within an acceptable time range.

In the experiment, 45 functional symptoms were selected that were detected during the database system release validation, and the operational costs were calculated between standard approaches and the described approaches for reproducing a target symptom. The described approaches outperformed the standard approach in all 45 cases, showing a reduction in operation time by factor of 24 (median) and request executions by factor of 541 (median). In 23 out of 45 cases, the described approaches consumed less than one minute for reproduction scenario extraction. The longest elapsed time was 46 minutes. In 20 out of 45 cases, the described approaches produced a simplified reproduction scenario with less than 1,000 predecessors. For the moderate outlier cases, an alternative approach would be reviewing the replay results of the predecessors and investigating suspicious outcomes and their co-relationships with the target symptom.

The approaches described herein provide a technique of extracting lineage of database requests for reproducing symptoms effectively out of real business-application request capture. An auxiliary data structure is employed which is used for transforming interdependence among requests by exploiting the transactional pattern of database request executions in the DBMS. The described approaches, then, simplify symptom analysis by isolating the symptom using the principle of semantic relatedness. As shown in the experimental section, a pre-aggregation of transactional dependency information can accelerate the predecessor search considerably even in extreme cases where the symptom analysis involves a complex database object hierarchy. The described approaches extract a symptom reproduction scenario that involves much lower operational costs and complexity while enabling flexibility for analysis.

### Example Computing Systems

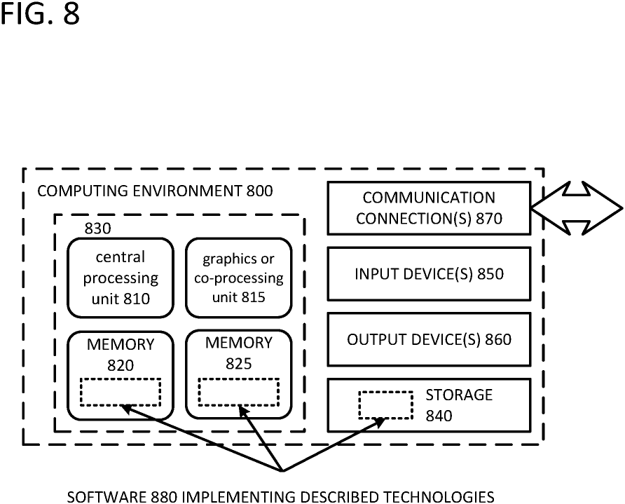

FIG. 8 depicts a generalized example of a suitable computing system 800 in which the described innovations may be implemented. The computing system 800 is not intended to suggest any limitation as to scope of use or functionality, as the innovations may be implemented in diverse general-purpose or special-purpose computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s). The memory 820, 825 stores software 880 implementing one or more innovations described herein, in the form of computer-executable instructions suitable for execution by the processing unit(s). For example, memory 820 and 825 can store dependency analyzer 216 of FIG. 2.

A computing system may have additional features. For example, the computing system 800 includes storage 840, one or more input devices 850, one or more output devices 860, and one or more communication connections 870. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 may be removable or non-removable, and includes magnetic disks, magnetic tapes or cassettes, CD-ROMs, DVDs, or any other medium which can be used to store information and which can be accessed within the computing system 800. The storage 840 stores instructions for the software 880 implementing one or more innovations described herein. For example, storage 840 can store dependency analyzer 216 of FIG. 2.

The input device(s) 850 may be a touch input device such as a keyboard, mouse, pen, or trackball, a voice input device, a scanning device, or another device that provides input to the computing system 800. For video encoding, the input device(s) 850 may be a camera, video card, TV tuner card, or similar device that accepts video input in analog or digital form, or a CD-ROM or CD-RW that reads video samples into the computing system 800. The output device(s) 860 may be a display, printer, speaker, CD-writer, or another device that provides output from the computing system 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer and should not be confused with acts performed by a human being. The actual computer operations corresponding to these terms vary depending on implementation.

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 8, computer-readable storage media include memory 820 and 825, and storage 840. The term computer-readable storage media does not include signals and carrier waves. In addition, the term computer-readable storage media does not include communication connections (e.g., 870).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

1. A method of generating an efficient error reproduction scenario, the method comprising:
retrieving workload capture data, the workload capture data including transaction information for a plurality of application requests;
consolidating the workload capture data according to transactional dependence of the plurality of application requests;
identifying an application request of interest;
using the consolidated workload capture data, determining a subset of the plurality of application requests on which the application request of interest is transactionally dependent; and
generating an error reproduction scenario for the application request of interest that includes the subset of application requests on which the application request of interest is transactionally dependent but excludes other application requests in the workload capture data on which the application request of interest is not transactionally dependent.

2. The method of claim 1, wherein the transaction information lists related objects for the respective application requests, and wherein consolidating the workload capture data further comprises grouping objects listed as related objects into object groups, wherein the respective groups correspond to object hierarchy trees.

3. The method of claim 2, wherein the grouping comprises:
upon determining that first and second objects are listed as related objects for one of the plurality of application requests in the workload capture data, assigning the first and second objects to a first object group; and
upon determining that for other of the plurality of application requests, one or more other objects are listed along with either the first or second objects as related objects, assigning the one or more other objects to the first object group.

4. The method of claim 2, further comprising generating a data structure relating identifiers for object groups and objects that form the corresponding object groups.

5. The method of claim 1, wherein the plurality of application requests comprises execute-type requests and postcommit-type requests, and wherein the respective postcommit-type requests correspond to one or more of the execute-type requests.

6. The method of claim 5, wherein consolidating the workload capture data further comprises grouping the execute-type requests according to identifiers of the corresponding postcommit-type requests.

7. The method of claim 6, wherein the transaction information lists related objects for the respective execute-type requests, wherein consolidating the workload capture data further comprises grouping objects listed as related objects into object groups, and wherein the execute-type requests are also grouped according to object group.

8. The method of claim 5, further comprising generating a data structure relating execute-type requests and corresponding postcommit-type requests.

9. The method of claim 1, further comprising generating one or more data structures representing the consolidated workload capture data, and wherein the subset of the plurality of application requests on which the application request of interest is transactionally dependent is determined by accessing the one or more data structures.

10. The method of claim 1, further comprising capturing the workload capture data during one or more application sessions.

11. The method of claim 1, wherein the error reproduction scenario is a debugging reproduction.

12. The method of claim 1, wherein generating the error reproduction scenario comprises ordering the plurality of application requests on which the application request of interest is transactionally dependent.

13. A computer memory configured to store a data structure, the data structure comprising:
a first portion linking objects to object groups, the respective object groups corresponding to object hierarchy trees of related objects, wherein the objects are listed as related objects for execute-type application requests in workload capture data, and wherein the related objects are grouped into object groups based on transactional dependence; and
a second portion linking postcommit-type application requests in the workload capture data with the object hierarchy trees and the execute-type application requests, wherein the respective postcommit-type requests correspond to one or more of the execute-type requests.

14. The computer memory of claim 13, wherein the first and second portions are tables.

15. The computer memory of claim 13, wherein the data structure is a consolidated version of the workload capture data that identifies transactional dependencies.

16. One or more computer storage devices storing computer-executable instructions for generating an efficient error reproduction scenario, the generating comprising:
for workload capture data that includes records of execute-type requests and records of postcommit-type requests:
grouping objects listed as related objects for the respective execute-type requests into object groups representing object hierarchy trees; and
grouping the execute-type requests according to both a corresponding postcommit-type request and an object group, wherein the grouped objects and execute-type requests form consolidated workload capture data;
identifying a portion of interest of the workload capture data;
using the consolidated workload capture data, determining a subset of the execute-type requests on which the portion of interest is transactionally dependent; and
generating an error reproduction scenario for the application request of interest that includes the subset of transactionally dependent execute-type requests and does not include other execute-type requests in the workload capture data.

17. The computer storage devices of claim 16, wherein the execute-type requests are also grouped by object group.

18. The computer storage devices of claim 16, wherein the generating comprises storing the grouped objects and grouped execute-type requests in one or more data structures, wherein the one or more data structures can be accessed to generate error reproduction scenarios for multiple portions of interest of the workload capture data.

19. The computer storage devices of claim 16, wherein the one or more data structures includes a first table linking object groups and related objects and a second table linking postcommit request identifiers, object group identifiers, and execute-type request identifiers.

20. The computer storage devices of claim 16, wherein the generating further comprises identifying a workload error using the error reproduction scenario.
